(19) United States
(12) Patent Application Publication
(10) Pub. No.: US 2025/0317178 A1
(43) Pub. Date: Oct. 9, 2025

(54) Methods For Reporting Channel State Information Associated With Unlicensed Band In Mobile Communications

(71) Applicant: MediaTek Inc., Hsinchu City (TW)

(72) Inventors: Chun-Hao Fang, Hsinchu City (TW); Lung-Sheng Tsai, Hsinchu City (TW)

(21) Appl. No.: 19/087,666

(22) Filed: Mar. 24, 2025

Related U.S. Application Data
(60) Provisional application No. 63/573,571, filed on Apr. 3, 2024.

(51) Int. Cl. H04B 7/06; H04L 5/00; H04W 24/10

(52) U.S. Cl. CPC H04B 7/0626; H04L 5/0051; H04W 24/10

(57) ABSTRACT

Various solutions for reporting channel state information (CSI) associated with unlicensed band with respect to an apparatus in mobile communications are described. The apparatus may measure a first reference signal in a licensed band and a second reference signal in an unlicensed band. The first reference signal may be associated with the second reference signal. The apparatus may determine a CSI based on measuring the second reference signal. The apparatus may report the CSI to a network node.

CROSS REFERENCE TO RELATED PATENT APPLICATION(S)

The present disclosure is part of a non-provisional application claiming the priority benefits of U.S. Patent Application No. 63/573,571, filed on 3 Apr. 2024, the content of which herein being incorporated by reference in its entirety.

### TECHNICAL FIELD

The present disclosure is generally related to mobile communications and, more particularly, to reporting channel state information (CSI) associated with unlicensed band with respect to apparatus in mobile communications.

### BACKGROUND

Unless otherwise indicated herein, approaches described in this section are not prior art to the claims listed below and are not admitted as prior art by inclusion in this section.

In New Radio (NR) mobile communication systems, a collaborative device may be deployed to enhance communication flexibility and robustness. In particular, a network node may connect to a user equipment (UE) and the collaborative device over a licensed band. The collaborative device may connect to the UE over an unlicensed band. Based on this architecture, the network node may transmit a signal to the UE and the collaborative device over the licensed band. Further, after receiving the signal, the collaborative device may process the received signal before transmitting it to the UE over the unlicensed band. Accordingly, the UE may receive the signal from a direct path (i.e., from the network node over the licensed band) and the processed signal from an indirect path (i.e., from the collaborative device over the unlicensed band).

However, to access the unlicensed band as communication channel between the UE and the collaborative device, uncertainty may exist on the availability of the local-link channel (i.e., the channel between the UE and the collaborative device). In certain scenarios, the acquisition of channel state information (CSI) may be impeded when reference signal(s) is (are) unable to traverse the unlicensed band due to a channel sensing procedure failure, which may significantly reduce the overall network efficiency.

Accordingly, how to prevent the acquisition of CSI from being impeded becomes important issues in the newly developed wireless communication network, and there is an urgent need to provide proper schemes to report CSI associated with unlicensed band.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to reporting channel state information (CSI) associated with unlicensed band with respect to apparatus in mobile communications.

In one aspect, a method may involve an apparatus measuring a first reference signal in a licensed band and a second reference signal in an unlicensed band. The first reference signal may be associated with the second reference signal. The method may also involve the apparatus determining a CSI based on measuring the second reference signal. The method may further involve the apparatus reporting the CSI to a network node.

In one aspect, a method may involve an apparatus transmitting a first reference signal to a first device and a second device in a licensed band. The first reference signal may be transformed into a second reference signal in an unlicensed band. The method may also involve the apparatus receiving a CSI from the first device. The CSI may be determined based on measuring the second reference signal in the unlicensed band.

In one aspect, a method may involve an apparatus receiving a first reference signal in a licensed band. The method may also involve the apparatus transforming the first reference signal into a second reference signal in an unlicensed band. The method may further involve the apparatus transmitting the second reference signal to a user equipment (UE) for determining a CSI based on measuring the second reference signal.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2 is a diagram depicting example scenarios under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reporting channel state information (CSI) associated with unlicensed band in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may wirelessly connect to a user equipment (UE) and a collaborative device over a licensed band. The UE and the collaborative device may connect with each other over an unlicensed band. The network node may transmit reference signal(s) (RS(s)) to the UE via: (1) a direct path between the UE and the network node, and (2) an indirect path between the collaborative device and the UE.

Accordingly, the UE may measure: (1) the RS(s) in the licensed band, and (2) the RS(s) in the unlicensed band. The UE may then determine a CSI based on measuring the RS(s) over the licensed band and/or the unlicensed band and report the CSI to the network node. Therefore, the network node may obtain the CSI associated with at least one of the licensed band and the unlicensed band.

In the present disclosure, the measurement of the RS(s) in the unlicensed band may be determined regardless of whether all sensing procedures associated with the unlicensed band between the UE and the collaborative device are successful, thereby the network node may obtain the CSI associated with at least one of the licensed band and the unlicensed band without any impediment.

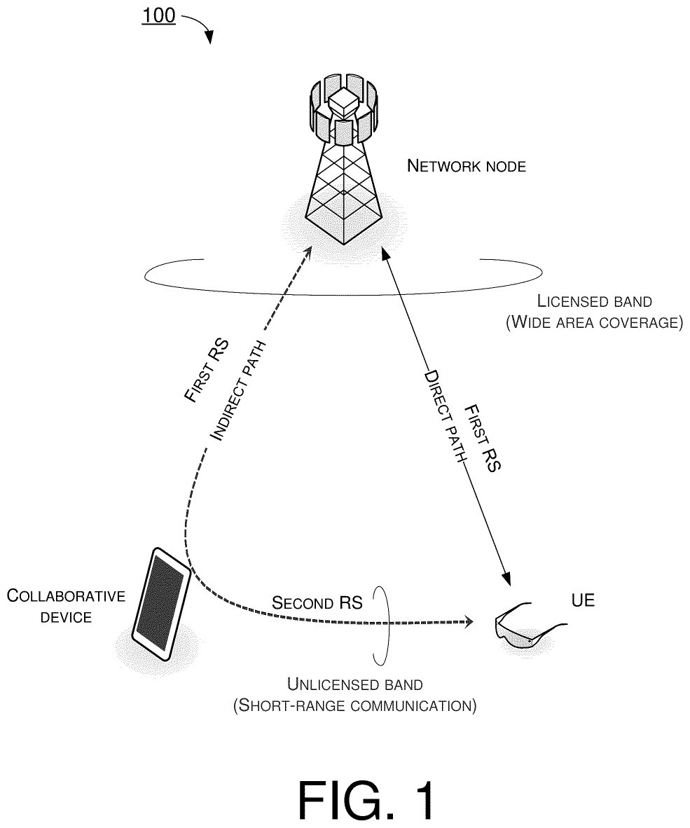

FIG. 1 illustrates an example scenario 100 under schemes in accordance with implementations of the present disclosure. Scenario 100 involves at least one network node, a UE and a collaborative device, which may be a part of a wireless communication network (e.g., an LTE network, a 5G/NR network, an IoT network or a 6G network).

Scenario 100 illustrates the current network framework. The network node may wirelessly connect to the UE and the collaborative device over a licensed band. In other words, the UE and the collaborative may camp on the same network node which may provide a wide area coverage for long-range communication. The UE and the collaborative device may connect with each other over an unlicensed band. In other words, the UE and the collaborative device may establish a short-range wireless connection with each other to perform a short-range communication over the unlicensed band. It should be noted that in the figures of the present application, the UE may be exemplified as a smart device, and the collaborative device may be exemplified as a smart phone. However, this is for illustrative purposes and not intended to be limiting.

In some embodiments, the network node may transmit a first RS to the UE via: (1) a direct path between the UE and the network node, and (2) an indirect path from the network node to the UE via the collaborative device. More specifically, regarding the indirect path, the collaborative device may receive the first RS and transform the first RS into a second RS. In some cases, the collaborative device may transform the first RS into the second RS by applying amplify-and-forward processing and perform frequency translation, and the second RS and the first RS correspond to a same baseband signal.

In some implementations, before transmitting the second RS to the UE, the collaborative device may determine a group of RB sets in the unlicensed band for transmitting the second RS by performing channel sensing procedure(s) (e.g., Listen-Before-Talk (LBT) procedure). In particular, the unlicensed band may include at least one resource block (RB) set. The UE and/or the collaborative device may perform a sensing procedure for each of the at least one RB set to determine the group of RB sets for transmitting the second reference signal. In some cases, the group of RB sets may be determined to be empty in an event that at least one of the sensing procedures is failed. In some cases, each RB set in the group of RB sets may be associated with a successful sensing procedure.

For example, the collaborative device performs a sensing procedure in the unlicensed band to determine whether or not to transmit signals carrying the second RS. Based on the result of the sensing procedure, the collaborative device may forward its received signal carrying the first RS in a licensed band to none, part of, or all RB sets within the unlicensed band. Due to the uncertainty that the second RS may be transmitted or not, the UE may sense whether the second RS is transmitted or not by detecting existence of the second RS. In other words, the UE and/or the collaborative device may identify whether the sensing procedure is successful for each of the at least one RB set. Then, The UE may measure the second RS over the at least one RB set after performing the sensing procedure(s).

In some implementations, after measuring the first RS over the licensed band via the direct path between the network node and the UE and measuring the second RS over the group of RB sets of the unlicensed band via the indirect path between the collaborative device and the UE, the UE may determine a CSI based on at least one of the measurements and report the CSI to the network node. In some cases, the CSI may include a first part and/or a second part. The first part may be associated with the first RS. The second part may be associated with the second RS. More specifically, the first part may include CSI parameter(s) estimated according to the first RS. The second part may include CSI parameter(s) estimated according to the second RS.

In some implementations, the CSI may include one of the following: (1) information for each of the at least one RB set; (2) information for a whole of the at least one RB set; or (3) information for a part of the at least one RB set while the part of the at least one RB set may be associated with successful sensing procedure. It should be noted that, in the following descriptions, “RB set(s) passing sensing procedure(s)” may represent that the collaborative device and/or the UE successfully perform a sensing procedure over the corresponding RB set (i.e., the collaborative device and/or the UE may occupy the RB set(s) and are capable of transmitting signal over the occupied RB set(s)).

In some cases, the information for each of the at least one RB set may include CSI parameter(s) for each of the at least one RB set. For example, the CSI parameter includes Channel Quality Indication (CQI). For each of the at least one RB set, when RB set ‘A’ passes a sensing procedure (e.g., LBT procedure), the information of RB set ‘A’ includes corresponding CQI which is not equal to zero. When RB set ‘A’ does not pass a sensing procedure (e.g., LBT procedure), the information of RB set ‘A’ includes corresponding CQI which is equal to zero.

In some cases, the information for the whole of the at least one RB set may include an average of CSI parameter(s). For example, the CSI parameter includes CQI. For each of the at least one RB set, a corresponding CQI is determined. Then, an average of the corresponding CQI(s) is calculated.

In some cases, the information for the part of the at least one RB set may include an average of CSI parameter(s) while the part of the at least one RB set may be associated with successful sensing procedure. For example, the CSI parameter includes CQI. For each of the at least one RB set that passes the corresponding sensing procedure (e.g., LBT procedure), a corresponding CQI is determined. Then, an average of the corresponding CQI(s) is calculated. In some cases, the information may further include an indicator indicating RB set(s) that does not pass the corresponding sensing procedure.

In some cases, the information may include an indicator indicating UE to stop measuring the second RS in an event that any of the at least one RB set does not pass the corresponding sensing procedure. For example, when there is one of the at least one RB set does not pass the sensing procedure (e.g., LBT procedure), the UE drops the second RS accordingly.

In some implementations, the CSI may include at least one of the following: (1) information of sensing procedure result for the at least one RB set; (2) information of successfully measuring the second RS; and (3) information of received power of measuring the second RS. In some implementations, the information mentioned may be determined by the collaborative device and transmitted from the collaborative device to the network node.

In some cases, the information of sensing procedure result for the at least one RB set may include quantity reporting sensing procedure result for the at least one RB set in the unlicensed band. For example, in an event that two RB sets pass the corresponding sensing procedures (e.g., LBT procedures), the information includes ‘2’. In some cases, the quantity reporting sensing procedure result may be determined by the UE itself. In some cases, the quantity reporting sensing procedure result may be received from the collaborative device (i.e., the quantity reporting sensing procedure result may be transmitted by the collaborative device).

In some cases, information of successfully measuring the second reference signal may include a quantity reflecting probability of successfully measuring the second RS. For example, the quantity is a probability of successful sensing procedure (e.g., LBT procedure) rate. For another example, the quantity is a ratio of unavailable probability to successful probability for channel access.

In some cases, the information of received power of measuring the second RS may include observed power or energy for energy detection of measuring the second RS.

In some implementations, after receiving the CSI including at least one of (1) the information of sensing procedure result for the at least one RB set; (2) the information of successfully measuring the second RS; and (3) the information of received power of measuring the second RS, the network node may transmit a physical downlink shared channel (PDSCH) transmission according to the CSI. For example, the network node may determine Rank Indication (RI) and/or Modulation and Coding Scheme (MCS) for later PDSCH. For another example, if the reported information quantity of successfully measuring the second RS is high, the network node may adopt RI and/or MCS according to previously received CSI corresponding to available local link (e.g., channel between the UE and the collaborative device), even if the latest received CSI may imply that the local link is not available. For another example, if the reported information quantity of successfully measuring the second RS is low, the network node may adopt link adaptation parameters (e.g., RI and/or MCS) according to previously received CSI corresponding to un-available local link, even if the latest received CSI may imply that the local link is available.

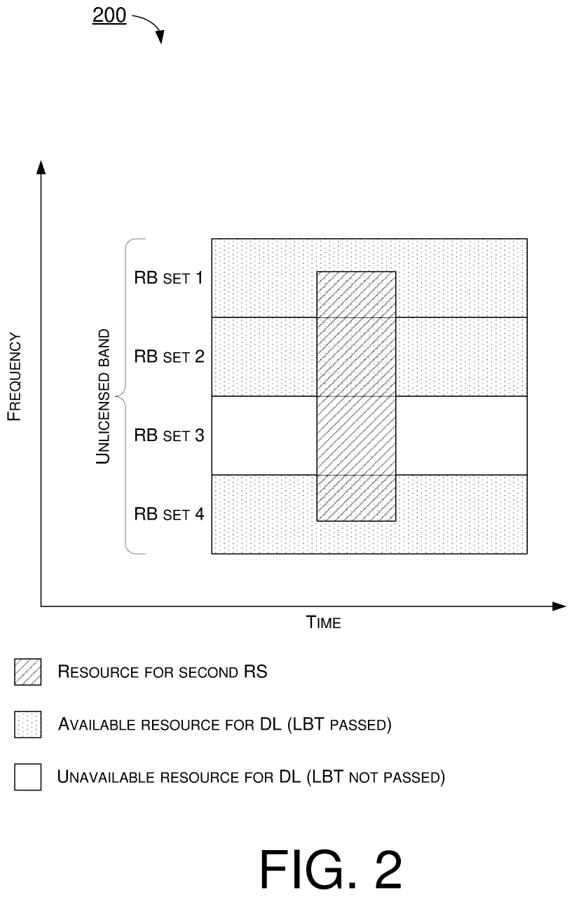

FIG. 2 illustrates an example scenario 200 under schemes in accordance with implementations of the present disclosure. For example, the unlicensed band includes four RB sets RB set 1 to RB set 4, each with a bandwidth of 20 megahertz (MHz). Before transmitting the second RS to the UE over the RB sets of the unlicensed band, the UE and/or the collaborative device perform an LBT procedure for each RB set.

In this example, LBT procedures for RB set 1, RB set 2 and RB set 4 are successful, which means that occupancies of RB set 1, RB set 2 and RB set 4 are obtained by the collaborative device and the UE for transmitting the second RS. LBT procedure for RB set 3 is failed, which means that occupancy of RB set 3 is not obtained by the collaborative device and/or the UE for transmitting the second RS.

In some scenarios, the UE determines CQIs ‘a’, ‘b’, ‘c’, ‘d’ for RB set 1 to RB set 4 while ‘c’ corresponding to RB set 3 is zero and each of ‘a’, ‘b’, ‘d’ corresponding to RB set 1, RB set 2, RB set 4 is not equal to zero. The UE reports CSI including CQIs ‘a’, ‘b’, ‘c’ and ‘d’ for RB set 1 to RB set 4 to the network node.

In some scenarios, the UE determines CQIs ‘a’, ‘b’, ‘c’, ‘d’ for RB set 1 to RB set 4 while ‘c’ corresponding to RB set 3 is zero and each of ‘a’, ‘b’, ‘d’ corresponding to RB set 1, RB set 2, RB set 4 is not equal to zero. The UE calculates an average of ‘a’, ‘b’, ‘c’, ‘d’ and reports CSI including the average to the network node.

In some scenarios, the UE determines CQIs ‘a’, ‘b’, ‘c’, ‘d’ for RB set 1 to RB set 4 while ‘c’ corresponding to RB set 3 is zero and each of ‘a’, ‘b’, ‘d’ corresponding to RB set 1, RB set 2, RB set 4 is not equal to zero. The UE calculates an average of ‘a’, ‘b’, ‘d’ and reports CSI including the average to the network node. In addition, the CSI report further includes an indicator indicating RB set 3 that does not pass the corresponding LBT procedure.

In some scenarios, the UE stops measuring the second RS since RB set 3 did not pass the corresponding LBT procedure. In other words, the UE drops the second RS since there is one RB set (i.e., RB set 3) did not pass the corresponding LBT procedure. Illustrative Implementations

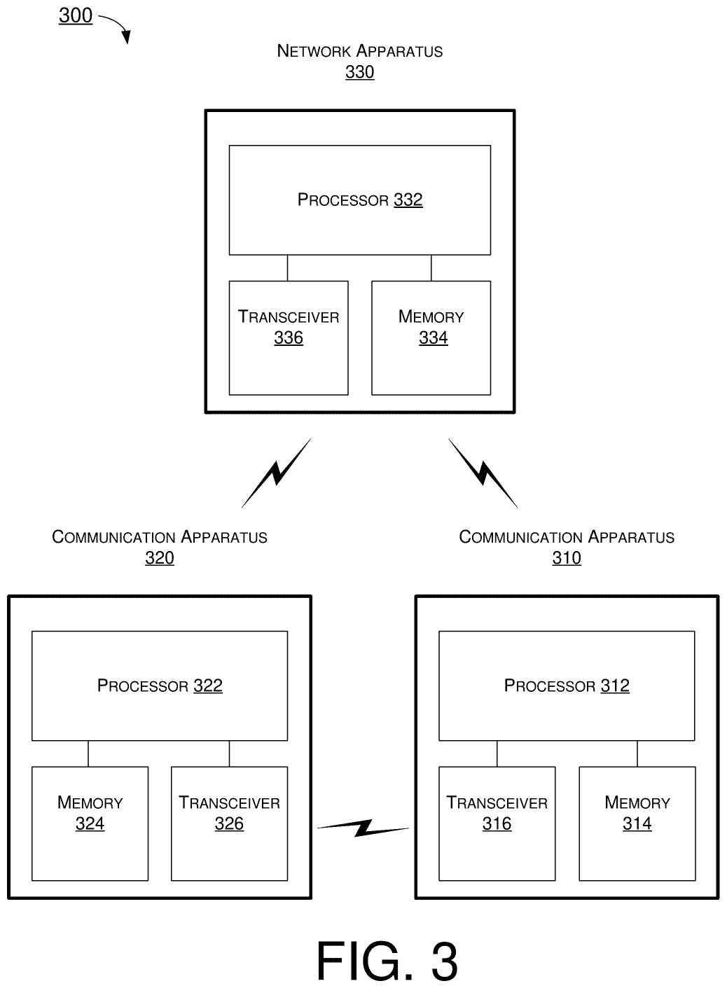

FIG. 3 illustrates an example communication system 300 having an example communication apparatus 310, an example communication apparatus 320, and an example network apparatus 330 in accordance with an implementation of the present disclosure. Each of communication apparatus 310, communication apparatus 320 and network apparatus 330 may perform various functions to implement schemes, techniques, processes and methods described herein pertaining to reporting CSI associated with unlicensed band in mobile communications, including scenarios/schemes described above as well as process 400, process 500 and process 600 described below.

Communication apparatus 310/320 may be a part of an electronic apparatus, which may be a UE such as a portable or mobile apparatus, a wearable apparatus, a mobile communication apparatus or a computing apparatus. For instance, communication apparatus 310/320 may be implemented in a smartphone, a smartwatch, a personal digital assistant, a digital camera, or a computing equipment such as a tablet computer, a laptop computer or a notebook computer. Communication apparatus 310/320 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310/320 may be implemented in a smart thermostat, a smart fridge, a smart door lock, a wireless speaker or a home control center. Alternatively, communication apparatus 310/320 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310/320 may include at least some of those components shown in FIG. 3 such as a processor 312/322, for example. Communication apparatus 310/320 may further include one or more other components not pertinent to the proposed scheme of the present disclosure (e.g., internal power supply, display device and/or user interface device), and, thus, such component(s) of communication apparatus 310/320 are neither shown in FIG. 3 nor described below in the interest of simplicity and brevity.

Network apparatus 330 may be a part of a network device, which may be a network node such as a satellite, a base station, a small cell, a router or a gateway. For instance, network apparatus 330 may be implemented in an eNodeB in an LTE network, in a gNB in a 5G/NR, IoT, NB-IoT or IioT network or in a satellite or base station in a 6G network. Alternatively, network apparatus 330 may be implemented in the form of one or more IC chips such as, for example and without limitation, one or more single-core processors, one or more multi-core processors, or one or more RISC or CISC processors. Network apparatus 330 may include at least some of those components shown in FIG. 3 such as a processor 332, for example. Network apparatus 330 may further include one or more other components not pertinent to the proposed scheme of the present disclosure (e.g., internal power supply, display device and/or user interface device), and, thus, such component(s) of network apparatus 330 are neither shown in FIG. 3 nor described below in the interest of simplicity and brevity.

In one aspect, each of processor 312, processor 322 and processor 332 may be implemented in the form of one or more single-core processors, one or more multi-core processors, or one or more CISC processors. That is, even though a singular term “a processor” is used herein to refer to processor 312, processor 322 and processor 332, each of processor 312, processor 322 and processor 332 may include multiple processors in some implementations and a single processor in other implementations in accordance with the present disclosure. In another aspect, each of processor 312, processor 322 and processor 332 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312, processor 322 and processor 332 is a special-purpose machine specifically designed, arranged and configured to perform specific tasks including reporting CSI associated with unlicensed band in a device (e.g., as represented by communication apparatus 310 and communication apparatus 320) and a network (e.g., as represented by network apparatus 330) in accordance with various implementations of the present disclosure.

In some implementations, communication apparatus 310 may also include a transceiver 316 coupled to processor 312 and capable of wirelessly transmitting and receiving data. In other words, processor 312 may transceive the data such as configuration, message, signal, information, indicator, etc. via transceiver 316. In some implementations, communication apparatus 310 may further include a memory 314 coupled to processor 312 and capable of being accessed by processor 312 and storing data therein. In some implementations, communication apparatus 320 may also include a transceiver 326 coupled to processor 322 and capable of wirelessly transmitting and receiving data. In other words, processor 322 may transceive the data such as configuration, message, signal, information, indicator, etc. via transceiver 326. In some implementations, communication apparatus 320 may further include a memory 324 coupled to processor 322 and capable of being accessed by processor 322 and storing data therein. In some implementations, network apparatus 330 may also include a transceiver 336 coupled to processor 332 and capable of wirelessly transmitting and receiving data. In other words, processor 332 may transceive the data such as configuration, message, signal, information, indicator, etc. via transceiver 336. In some implementations, network apparatus 330 may further include a memory 334 coupled to processor 332 and capable of being accessed by processor 332 and storing data therein. Accordingly, communication apparatus 310, communication apparatus 320 and network apparatus 330 may wirelessly communicate with each other via transceiver 316, transceiver 326 and transceiver 336, respectively. To aid better understanding, the following description of the operations, functionalities and capabilities of each of communication apparatus 310, 320 and network apparatus 330 is provided in the context of a mobile communication environment in which communication apparatus 310, 320 are implemented in or as a communication apparatus or a UE and network apparatus 330 is implemented in or as a network node of a communication network.

In some implementations, each of memory 314, 324 and 334 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314, 324 and 334 may include a type of read-only memory (ROM) such as mask ROM, programmable ROM (PROM), erasable programmable ROM (EPROM) and/or electrically erasable programmable ROM (EEPROM). Alternatively, or additionally, each of memory 314, 324 and 334 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

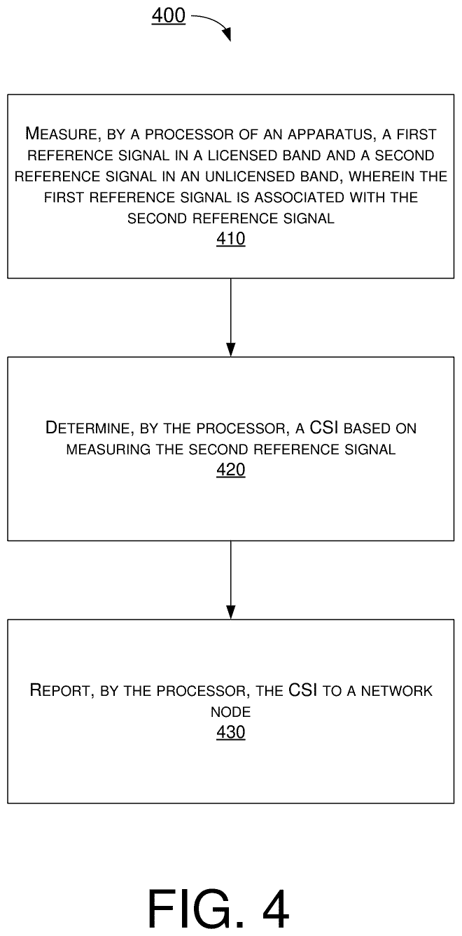

FIG. 4 illustrates an example process 400 in accordance with an implementation of the present disclosure. Process 400 may be an example implementation of above scenarios/schemes, whether partially or completely, with respect to reporting CSI associated with unlicensed band in mobile communications of the present disclosure. Process 400 may represent an aspect of implementation of features of communication apparatus 310. Process 400 may include one or more operations, actions, or functions as illustrated by one or more of blocks 410 to 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable communication device or machine type devices. Solely for illustrative purposes and without limitation, process 400 is described below in the context of communication apparatus 310. Process 400 may begin at block 410.

At block 410, process 400 may involve processor 312 of communication apparatus 310 measuring a first reference signal in a licensed band and a second reference signal in an unlicensed band. The first reference signal may be associated with the second reference signal. Process 400 may proceed from block 410 to block 420.

At block 420, process 400 may involve processor 312 determining a CSI based on measuring the second reference signal. Process 400 may proceed from block 420 to block 430.

At block 430, process 400 may involve processor 312 reporting the CSI to a network node.

In some implementations, the channel state information may be determined further based on measuring the first reference signal.

In some implementations, the second reference signal in the unlicensed band may be measured over at least one RB set.

In some implementations, the CSI may include: (1) information for each of the at least one RB set, (2) information for a whole of the at least one RB set, or (3) information for a part of the at least one RB set while the part of the at least one RB set may be associated with successful sensing procedure.

In some implementations, the CSI may include at least one of: (1) information of sensing procedure result for the at least one RB set, (2) information of successfully measuring the second reference signal, and (3) information of received power of measuring the second reference signal.

In some implementations, the information of sensing procedure result for the at least one RB set may be received from another device or determined by communication apparatus 310.

In some implementations, process 400 may further involve processor 312 identifying whether a sensing procedure is successful for each of the at least one RB set.

In some implementations, the CSI may include a first part and a second part. The first part may be associated with the first reference signal, and the second part may be associated with the second reference signal.

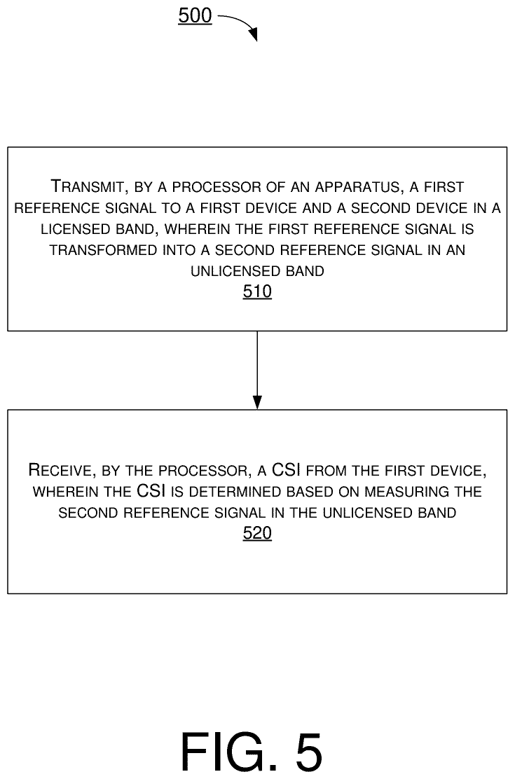

FIG. 5 illustrates an example process 500 in accordance with an implementation of the present disclosure. Process 500 may be an example implementation of above scenarios/schemes, whether partially or completely, with respect to reporting CSI associated with unlicensed band in mobile communications of the present disclosure. Process 500 may represent an aspect of implementation of features of network apparatus 330. Process 500 may include one or more operations, actions, or functions as illustrated by one or more of blocks 510 to 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 330 or any suitable network device or machine type devices. Solely for illustrative purposes and without limitation, process 500 is described below in the context of network apparatus 330. Process 500 may begin at block 510.

At block 510, process 500 may involve processor 332 of network apparatus 330 transmitting a first reference signal to a first device and a second device in a licensed band. The first reference signal may be transformed into a second reference signal in an unlicensed band. Process 400 may proceed from block 510 to block 520.

At block 520, process 500 may involve processor 332 receiving a CSI from the first device. The CSI may be determined based on measuring the second reference signal in the unlicensed band.

In some implementations, the second reference signal in the unlicensed band may be measured over at least one RB set.

In some implementations, the CSI may include: (1) information for each of the at least one RB set, (2) information for a whole of the at least one RB set, or (3) information for a part of the at least one RB set while the part of the at least one RB set may be associated with successful sensing procedure.

In some implementations, the CSI may include at least one of: (1) information of sensing procedure result for the at least one RB set, (2) information of successfully measuring the second reference signal, and (3) information of received power of measuring the second reference signal.

In some implementations, process 500 may further involve processor 332 determining a PDSCH according to the CSI.

In some implementations, the CSI may be determined further based on measuring the first reference signal.

In some implementations, the CSI may include a first part and a second part. The first part may be associated with the first reference signal, and the second part may be associated with the second reference signal.

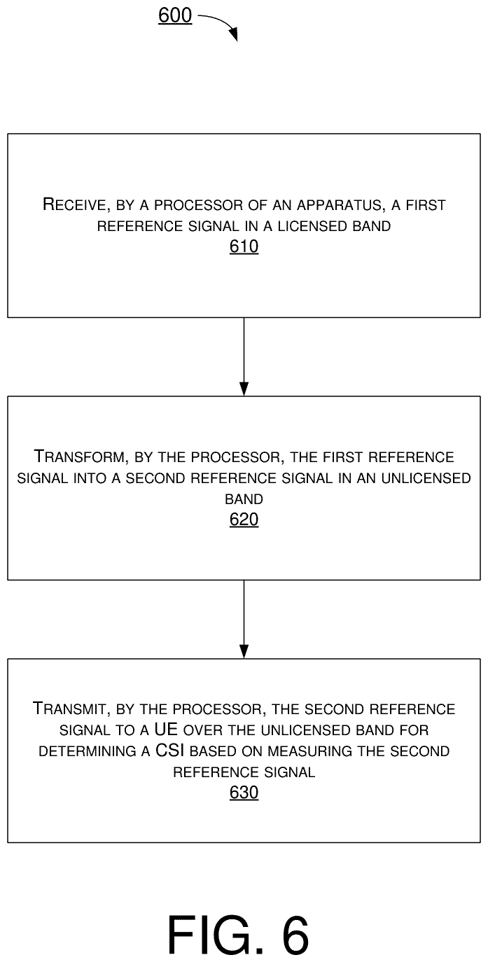

FIG. 6 illustrates an example process 600 in accordance with an implementation of the present disclosure. Process 600 may be an example implementation of above scenarios/schemes, whether partially or completely, with respect to reporting CSI associated with unlicensed band in mobile communications of the present disclosure. Process 600 may represent an aspect of implementation of features of communication apparatus 320. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 320 or any suitable communication device or machine type devices. Solely for illustrative purposes and without limitation, process 600 is described below in the context of communication apparatus 320. Process 600 may begin at block 610.

At block 610, process 600 may involve processor 322 of communication apparatus 320 receiving a first reference signal in a licensed band. Process 600 may proceed from block 610 to block 620.

At block 620, process 600 may involve processor 322 transforming the first reference signal into a second reference signal in an unlicensed band. Process 600 may proceed from block 620 to block 630.

At block 630, process 600 may involve processor 322 transmitting the second reference signal to a UE over the unlicensed band for determining a CSI based on measuring the second reference signal.

In some implementations, process 600 may further involve processor 322 determining a group of RB sets in the unlicensed band. The second reference signal may be transmitted to the UE in the group of RB sets.

In some implementations, process 600 may further involve processor 322 determining the group of RB sets from at least one RB set in the unlicensed band by performing at least one sensing procedure in the at least one RB set.

In some implementations, the group of RB sets may be determined to be empty in an event that at least one of the sensing procedures is failed.

In some implementations, each RB set in the group of RB sets may be associated with a successful sensing procedure.

In some implementations, the second reference signal in the unlicensed band may be measured over at least one RB set.

In some implementations, the CSI may include: (1) information for each of the at least one RB set, (2) information for a whole of the at least one RB set, or (3) information for a part of the at least one RB set while the part of the at least one RB set may be associated with successful sensing procedure.

In some implementations, process 600 may further involve processor 322 transmitting at least one of the following to a network node: (1) information of sensing procedure result for the at least one RB set, (2) information of successfully measuring the second reference signal, and (3) information of received power of measuring the second reference signal.

In some implementations, the information of sensing procedure result for the at least one RB set may be determined and transmitted to the UE by communication apparatus 320 or determined by the UE.

In some implementations, process 600 may further involve processor 322 identifying whether a sensing procedure is successful for each of the at least one RB set.

In some implementations, the CSI may include a first part and second part. The first part may be associated with the first reference signal, and the second part may be associated with the second reference signal.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
measuring, by a processor of an apparatus, a first reference signal in a licensed band and a second reference signal in an unlicensed band, wherein the second reference signal is associated with the first reference signal;
determining, by the processor, a channel state information based on measuring the second reference signal; and
reporting, by the processor, the channel state information to a network node.

2. The method of claim 1, wherein the channel state information is determined further based on measuring the first reference signal.

3. The method of claim 1, wherein the second reference signal in the unlicensed band is measured over at least one resource block (RB) set.

4. The method of claim 3, wherein the channel state information includes:
information for each of the at least one RB set;
information for a whole of the at least one RB set; or
information for a part of the at least one RB set, wherein the part of the at least one RB set is associated with successful sensing procedure.

5. The method of claim 3, wherein the channel state information includes at least one of:
information of sensing procedure result for the at least one RB set;
information of successfully measuring the second reference signal; and
information of received power of measuring the second reference signal.

6. The method of claim 5, wherein the information of sensing procedure result for the at least one RB set is received from another device or determined by the apparatus.

7. The method of claim 3, further comprising:
identifying, by the processor, whether a sensing procedure is successful for each of the at least one RB set.

8. The method of claim 2, wherein the channel state information includes a first part and a second part, the first part is associated with the first reference signal, and the second part is associated with the second reference signal.

9. A method, comprising:
transmitting, by a processor of an apparatus, a first reference signal to a first device and a second device in a licensed band, wherein the first reference signal is transformed into a second reference signal in an unlicensed band; and
receiving, by the processor, a channel state information from the first device, wherein the channel state information is determined based on measuring the second reference signal in the unlicensed band.

10. The method of claim 9, wherein the second reference signal in the unlicensed band is measured over at least one resource block (RB) set.

11. The method of claim 10, wherein the channel state information includes:
information for each of the at least one RB set;
information for a whole of the at least one RB set; or
information for a part of the at least one RB set, wherein the part of the at least one RB set is associated with successful sensing procedure.

12. The method of claim 10, wherein the channel state information includes at least one of:
information of sensing procedure result for the at least one RB set;
information of successfully measuring the second reference signal; and
information of received power of measuring the second reference signal.

13. The method of claim 9, further comprising:
determining, by the processor, a physical downlink shared channel (PDSCH) transmission according to the channel state information.

14. The method of claim 9, wherein the channel state information is determined further based on measuring the first reference signal.

15. The method of claim 14, wherein the channel state information includes a first part and a second part, the first part is associated with the first reference signal, and the second part is associated with the second reference signal.

16. A method, comprising:
receiving, by a processor of an apparatus, a first reference signal in a licensed band;
transforming, by the processor, the first reference signal into a second reference signal in an unlicensed band; and
transmitting, by the processor, the second reference signal to a user equipment (UE) over the unlicensed band for determining a channel state information based on measuring the second reference signal.

17. The method of claim 16, further comprising:
determining, by the processor, a group of RB sets in the unlicensed band, wherein the second reference signal is transmitted to the UE in the group of RB sets.

18. The method of claim 17, wherein determining the group of RB set in the unlicensed band further comprises:
determining, by the processor, the group of RB sets from at least one RB set in the unlicensed band by performing at least one sensing procedure in the at least one RB set.

19. The method of claim 18, wherein the group of RB sets is determined to be empty in an event that at least one of the sensing procedures is failed.

20. The method of claim 18, wherein each RB set in the group of RB sets is associated with a successful sensing procedure.
